(19) United States
(12) Patent Application Publication
(10) Pub. No.: US 2014/0036513 A1
(43) Pub. Date: Feb. 6, 2014

(54) LIGHTING DEVICE AND LIGHTING DEVICE MANUFACTURING METHOD

(71) Applicant: Funai Electric Co., Ltd., Osaka (JP)

(72) Inventor: Yukikazu NOBATA, Osaka (JP)

(21) Appl. No.: 13/940,720

(22) Filed: Jul. 12, 2013

(30) Foreign Application Priority Data
Jul. 31, 2012 (JP) 2012-169429

(51) Int. Cl. F21V 23/00

(52) U.S. Cl. CPC F21V 23/004
USPC 362/362; 29/830

(57) ABSTRACT

A lighting device includes a light source component, a circuit board component, and a case component. The circuit board component is configured to supply power to the light source component. The case component houses the circuit board component in an interior of the case component. The circuit board component includes first and second circuit board components. The first circuit board component has a first mounting surface on which a first electronic part is mounted. The second circuit board component has a second mounting surface on which a second electronic part is mounted. The second mounting surface of the second circuit board component overlaps with the first mounting surface of the first circuit board component.

### CROSS-REFERENCE TO RELATED APPLICATIONS

This application claims priority to Japanese Patent Application No. 2012-169429 filed on Jul. 31, 2012. The entire disclosure of Japanese Patent Application No. 2012-169429 is hereby incorporated herein by reference.

### BACKGROUND

1. Field of the Invention

The present invention generally relates to a lighting device and to a lighting device manufacturing method. More specifically, the present invention relates to a lighting device having a case component and a circuit board component disposed within the case component, and to a lighting device manufacturing method for manufacturing the lighting device.

2. Background Information

Lighting devices with a circuit board component and a case component are well-known (see Japanese Laid-Open Patent Application Publication No. 2012-59494 (Patent Literature 1), for example). A plurality of electronic parts is mounted on the circuit board component. The circuit board component is housed in the case component.

In particular, the above-mentioned Patent Literature 1 illustrates a light bulb-shaped lamp (lighting device) having a light source unit (light source component), a switching circuit board (circuit board component), and a cylindrical cover component (case component). A plurality of switching circuit parts (electronic parts) is mounted on the switching circuit board. The switching circuit board is used to supply power to the light source unit. The cylindrical cover component has a bottom part. The switching circuit board is housed in an interior of the cylindrical cover. The switching circuit board of this light bulb-shaped lamp has a shape that is substantially taller than it is wide. The switching circuit board is configured such that the switching circuit board is slid into the cover component in a state in which the lengthwise direction (length direction) of the switching circuit board is aligned with the lengthwise direction of the cover component. Therefore, the cover component has an external shape that is taller than it is wide, so as to correspond to the external shape (taller than wide) of the switching circuit board.

### SUMMARY

With the light bulb-shaped lamp discussed in Patent Literature 1, the switching circuit board having a shape that is substantially taller than it is wide has to be covered and hidden by being inserted into the cover component in the lengthwise direction (length direction. It has been discovered that the cover component has to be formed that much larger in the length direction, and that the lighting device as a whole ends up being larger.

One object of the present disclosure is to provide a lighting device with which an increase in size of the lighting device as a whole can be reduced. Furthermore, another object of the present disclosure is to provide a lighting device manufacturing method.

In view of the state of the know technology, a lighting device includes a light source component, a circuit board component, and a case component. The circuit board component is configured to supply power to the light source component. The case component houses the circuit board component in an interior of the case component. The circuit board component includes first and second circuit board components. The first circuit board component has a first mounting surface on which a first electronic part is mounted. The second circuit board component has a second mounting surface on which a second electronic part is mounted. The second mounting surface of the second circuit board component overlaps with the first mounting surface of the first circuit board component.

Other objects, features, aspects and advantages of the present disclosure will become apparent to those skilled in the art from the following detailed description, which, taken in conjunction with the annexed drawings, discloses a preferred embodiment of a lighting device and a lighting device manufacturing method.

### BRIEF DESCRIPTION OF THE DRAWINGS

Referring now to the attached drawings which form a part of this original disclosure:

FIG. 1 is an exploded perspective view of an LED lighting device in accordance with a first embodiment;

FIG. 2 is a perspective view of the LED lighting device illustrated in FIG. 1;

FIG. 3 is a cross sectional view of the LED lighting device illustrated in FIG. 2;

FIG. 4 is a plan view of a large circuit board for producing a circuit board component of the LED lighting device illustrated in FIG. 1, with the large circuit board manufactured prior to an assembly of the circuit board component into the LED lighting device;

FIG. 5 is a side elevational view of the circuit board component installed into the LED lighting device illustrated in FIG. 1;

FIG. 6 is a cross sectional view of an LED lighting device in accordance with a second embodiment; and

FIG. 7 is a side elevational view of a circuit board component installed into the LED lighting device illustrated in FIG. 6.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

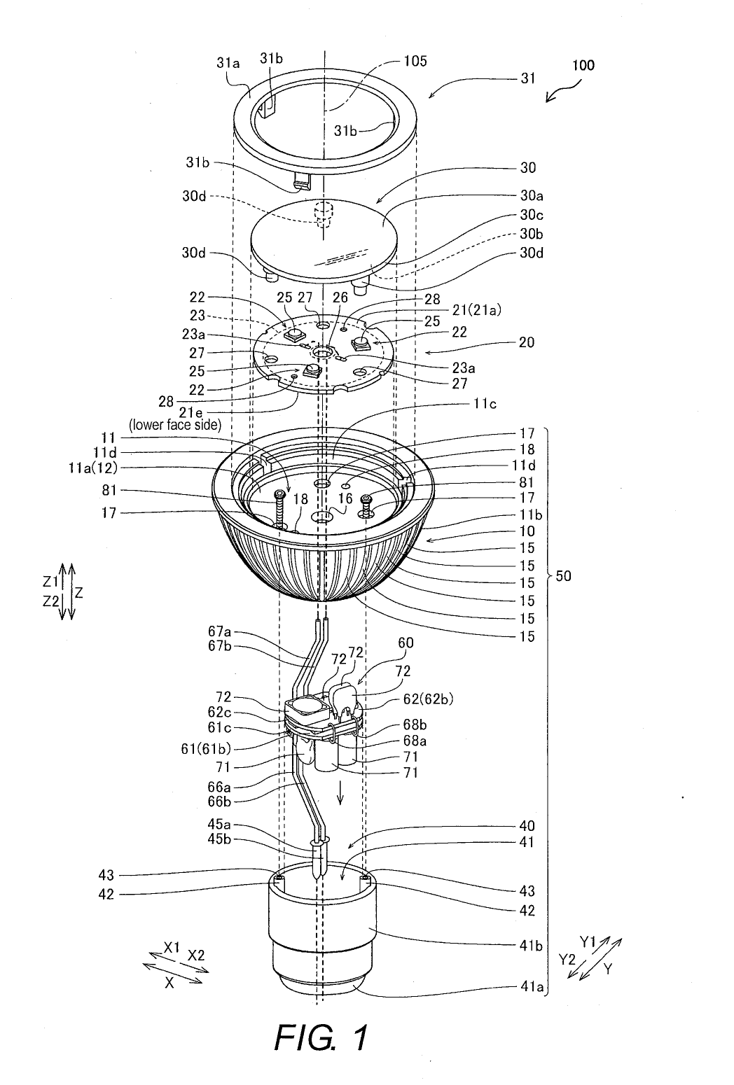

Referring initially to FIGS. 1 to 3, an LED lighting device 100 is illustrated in accordance with a first embodiment. In the illustrated embodiment, the LED lighting device 100 is a spotlight type of LED (light-emitting diode) lighting device. The LED lighting device 100 is an example of the “lighting device” of the present invention.

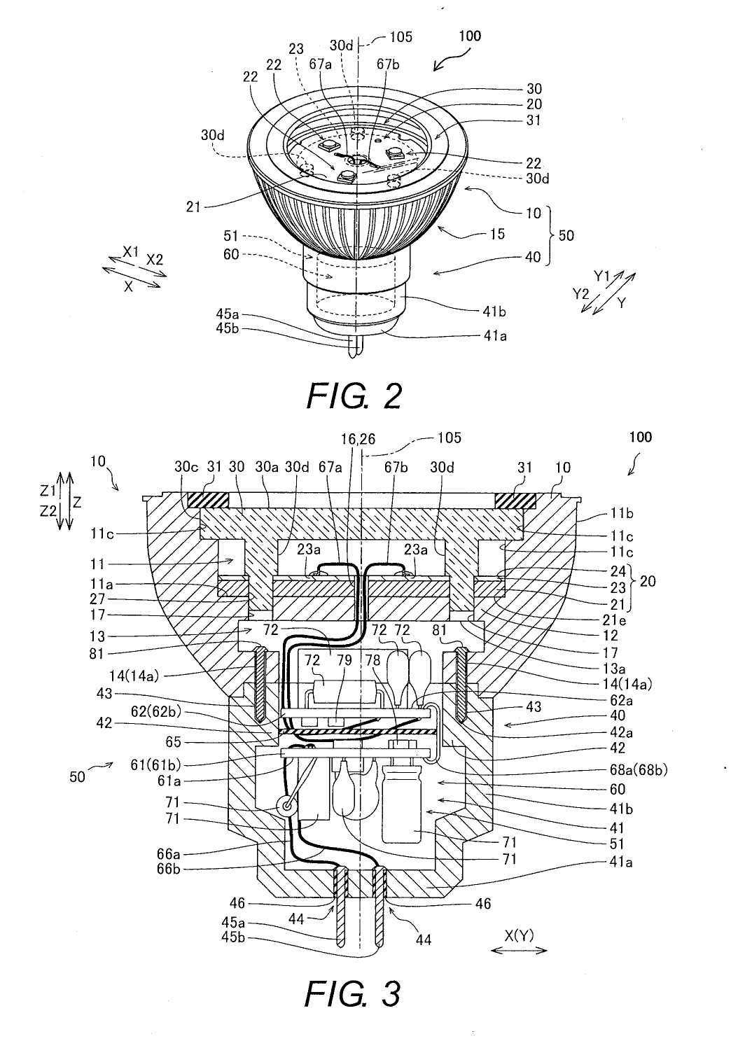

As shown in FIG. 1, the LED lighting device 100 includes a housing 10, an LED board 20, a lens member 30, a lens holder 31, and a socket 40. The LED lighting device 100 further includes a circuit board component 60. The circuit board component 60 is disposed inside the socket 40, and is used to supply power to the LED board 20. The spotlight type of LED lighting device 100 shown in FIG. 2 is completed by combining all the constituent parts discussed above. The LED lighting device 100 is installed into the ceiling or walls of stores, etc., and is mainly used for displays, such as merchandise displays. The housing 10 and the socket 40 are examples of the “case component” of the present invention. The LED board 20 is an example of the “light source component” of the present invention.

As shown in FIG. 1, the housing 10 is made from metal, such as aluminum. The housing 10 is in the form of a substantially circular pot whose diameter increases as moving towards one end (the Z1 side) from the other end (the Z2 side) along a center axis line 105 (the Z direction) (see FIGS. 2 and 3). The housing 10 includes a bottom face 11a and a cylindrical outer wall part 11b. The bottom face 11a is recessed inward (in the Z2 direction) along the center axis line 105, and is disposed at the end with the larger diameter (the Z1 side). The outer wall part 11b has an inner face 11c. The inner face 11c extends from the outer peripheral part of the bottom face 11a while increasing in diameter in stages toward the end on the Z1 direction side. The bottom face 11a and the outer wall part 11b form a concave component 11 in the housing 10.

As shown in FIG. 3, the housing 10 also includes a partition 12. The partition 12 extends in the radial direction (X direction or Y direction), and forms the bottom face 11a of the concave component 11. Also, the housing 10 includes a bottom face 13a. The bottom face 13a is recessed inward (in the Z1 direction) along the center axis line 105 at the other end with the reduced diameter (the Z2 side). The bottom face 13a is disposed on the opposite side (the Z2 side) from the bottom face 11a of the partition 12. The bottom face 13a and the outer wall part 11b, which extends while the other end on the side in the Z2 direction decreases in diameter, form a concave component 13 in the housing 10. A pair of bosses 14 each having a hole 14a is integrally formed in the inner face of the concave component 13. As shown in FIG. 1, a plurality of (twenty-four in this embodiment) fins 15 is formed on the outer face of the outer wall part 11b. The fins 15 are spaced apart by a specific distance in the peripheral direction (at a spacing of approximately 15 degrees around the center axis line 105).

As shown in FIG. 1, a hole 16 is provided near the center of the bottom face 11a of the housing 10. The hole 16 passes through the partition 12 (see FIG. 2) in the thickness direction (Z direction). Furthermore, three holes 17 (with large diameter) and two threaded holes 18 (with small diameter) are provided in a region that is further outside than the hole 16 of the bottom face 11a. The holes 17 and the threaded holes 18 pass through in the thickness direction. The LED board 20 (discussed below) is attached to the bottom face 11a. A plurality of notches 11d is formed (at a total of three places in this embodiment) in the inner face 11c of the outer wall part 11b. The notches 11d are spaced apart by a spacing of approximately 120 degrees in the peripheral direction.

As shown in FIG. 1, the LED board 20 includes an aluminum base component 21 and a plurality of (three in this embodiment) LED element components 22 that is mounted on a mounting face (or upper face) 21a of the base component 21. Each of the LED element components 22 is connected to a wiring pattern 23 (indicated by a broken line). The wiring pattern 23 is made of copper foil formed via an insulating film (not shown) on the mounting face 21a of the base component 21. The surface (Z2 side) of the wiring pattern 23 is covered by a coating film 24 (see FIG. 3) except for lands 23a (two places) where the copper foil is exposed. The coating film 24 also uniformly covers the mounting face 21a of the base component 21 where the wiring pattern 23 is not formed, in addition to the surface of the wiring pattern 23. In FIG. 3, the thickness of the wiring pattern 23 is shown slightly exaggerated. The individual LED element components 22 include a plurality of LED elements (not shown) and plastic diffusers 25 that cover the LED elements in a dome shape (hemispherical shape) (see FIG. 1).

A hole 26, three holes 27 (with large diameter) and two holes 28 (with small diameter) are provided to the LED board 20. The hole 26 passes through in the thickness direction (Z direction) near the center of the LED board 20. The holes 27 and the holes 28 pass through in the thickness direction in a region further to the outside than the wiring pattern 23. A threaded member (not shown) is inserted and fastened from the LED board 20 side in a state in which the holes 28 of the LED board 20 and the threaded holes 18 of the housing 10 (concave component 11) are overlapping. This allows the LED board 20 to be fixed to the housing 10 (concave component 11) in a state in which the non-mounting face (lower face) 21e of the LED board 20 is pressed snugly against the bottom face 11a inside the concave component 11, as shown in FIG. 3. Consequently, any heat generated by the LED board 20 is released to the housing 10 via the bottom face 11a. Also, as shown in FIG. 3, legs 30d of the lens member 30 (discussed below) are inserted up to a specific depth position in the holes 27.

As shown in FIG. 3, the lens member 30 is made of a translucent resin material. The lens member 30 is formed substantially in a disk shape around the center axis line 105 (the Z direction). Specifically, the lens member 30 includes an upper face 30a, a lower face 30b, and a circular outer peripheral face 30c that connects the upper face 30a and the lower face 30b in the Z direction. The lens member 30 also has three integral legs 30d protruding downward from the lower face 30b. Consequently, the lens member 30 is attached with substantially no gaps to the housing 10 by fitting the outer peripheral face 30c of the lens member 30 into the concave component 11 while bringing it into contact all the way around the inner face 11c located near the opening of the concave component 11 of the housing 10. Also, the cylindrical legs 30d have a stepped part machined such that the base portions of the legs 30d closer to the lower face 30b have a different diameter from that of the distal end portions of the legs 30d on the opposite side (the base portion is thicker, and the distal end portion is thinner). Consequently, the amount in which the legs 30d are inserted (the plug-in depth) is adjusted, and the lens member 30 is positioned in the depth direction (the Z2 direction). Specifically, the wider diameter portion (the stepped part) at the boundary between the distal end portion and the base portion abuts against the mounting face 21a at the point when the legs 30d are inserted to a specific depth into the holes 27 in the LED board 20 from the distal end portion.

A plurality of engagement prongs 31b (at a total of three sites) are formed on the lens holder 31. The engagement prongs 31b protrude downward (in the Z2 direction) from an annular frame component 31a, and are spaced apart by approximately 120 degrees in the peripheral direction. Therefore, the lens holder 31 is fitted into the housing 10 downward (the Z2 direction) from above (the Z1 side) in a state in which the engagement prongs 31b of the lens holder 31 are aligned with the notches 11d in the housing 10. Consequently, the lens holder 31 is used to fix the lens member 30 to the housing 10.

As shown in FIG. 3, the socket 40 is made of metal, such as aluminum. The socket 40 includes a bottom part 41a and a circular cylindrical wall part 41b. The bottom part 41a is disposed at the other end (the Z2 side) along the center axis line 105 (in the Z direction). The wall part 41b extends from the outer peripheral part of the bottom part 41a toward the one end (in the Z1 direction). The bottom part 41a and the wall part 41b form a concave component 41 in the socket 40. As shown in FIG. 1, a pair of convex bosses 42 is integrally formed at the one end (on the Z1 side) of the wall part 41b where the concave component 41 opens. Threaded holes 43 are provided to the bosses 42, respectively. As shown in FIG. 3, a pair of through-holes 44 is formed in the bottom part 41a. A pair of metal terminal members 45a and 45b is fitted into the through-holes 44, respectively, via insulating members 46. The terminal members 45a and 45b are electrically insulated from each other by the insulating members 46. The terminal members 45a and 45b are fixed in the through-holes 44 along with the insulating members 46.

Because the housing 10 and the socket 40 are constituted as above, the LED lighting device 100 is assembled from the state in FIG. 1 into the state in FIG. 2. Specifically, threaded members 81 are inserted through the holes 17 from the bottom face 11a side in a state in which the side of the housing 10 on which the concave component 13 (see FIG. 3) is formed (the Z2 side) is opposite the side of the socket 40 on which the concave component 41 opens, and in which the LED board 20 has not been attached. The threaded members 81 are inserted into the holes 14a in the bosses 14 underneath, and are fastened into the threaded holes 43 of the concave component 41 underneath. This links the housing 10 to the socket 40. The housing 10 and the socket 40 form a case component 50 of the LED lighting device 100.

As shown in FIG. 3, in the first embodiment, in a state in which the concave component 13 of the housing 10 and the concave component 41 of the socket 40 have been linked to form the case component 50, a space 51 (a space formed by the concave component 13 and the concave component 41) is formed inside the case component 50. The circuit board component 60 is housed in this space 51. The configuration of the circuit board component 60 will now be described in detail.

As shown in FIG. 3, the circuit board component 60 includes a first circuit board component 61 and a second circuit board component 62. The first circuit board component 61 functions as a power supply circuit board component that converts AC power into DC power. A plurality of electronic parts 71 and 78 related to power management in the LED lighting device 100 is mounted on the first circuit board component 61. The first circuit board component 61 has a first board 61b having a first mounting surface 61a on which the main electronic parts 71 are mounted. The second circuit board component 62 functions as a control circuit board component that controls the voltage of the DC power converted by the first circuit board component 61 and supplies it to the LED board 20. A plurality of electronic parts 72 and 79 related to switching control in the LED lighting device 100 is mounted on the second circuit board component 62. The second circuit board component 62 has a second board 62b having a second mounting surface 62a on which the main electronic parts 72 are mounted. The term “main electronic parts 71” means electronic parts that are relatively large in size (length, width, and height) with respect to the electronic parts 78. The main electronic parts 71 are electronic parts that are mounted on the first board 61b in order to carry out the main functions of the power supply circuit board component. Similarly, the term “main electronic parts 72” means electronic parts that are relatively large in size (length, width, and height) with respect to the electronic parts 79. The main electronic parts 72 are electronic parts that are mounted on the second board 62b in order to carry out the main functions of the control circuit board component. The electronic parts 71 are examples of the “first electronic parts” of the present invention, while the electronic parts 72 are examples of the “second electronic parts” of the present invention.

As shown in FIG. 3, in the first embodiment, the circuit board component 60 is configured in a state in which the first mounting surface 61a of the first circuit board component 61 (the first board 61b) and the second mounting surface 62a of the second circuit board component 62 (the second board 62b) are disposed overlapping in the Z direction. The circuit board component 60 is housed in the space 51 bounded by the concave component 41 inside the socket 40 (the case component 50) while the first mounting surface 61a of the first circuit board component 61 overlaps with the second mounting surface 62a of the second circuit board component 62. Specifically, inside the case component 50, the first mounting surface 61a and the second mounting surface 62a, each of which has been made more compact by being divided in two, overlap in planar fashion so that the first circuit board component 61 and the second circuit board component 62 are disposed three-dimensionally. In other words, the circuit board component 60 is housed in the case component 50 with a two-level structure formed by the first circuit board component 61 and the second circuit board component 62.

In the first embodiment, the first mounting surface 61a (first board 61b) and the second mounting surface 62a (second board 62b) overlap in the direction (Z direction) in which the socket 40 extends in the space 51 that is bounded by the concave component 41 inside the socket 40. Here, the first circuit board component 61 and the second circuit board component 62 overlap such that the first mounting surface 61a and the second mounting surface 62a on which the main electronic parts 71 and 72 are respectively mounted face in mutually opposite directions (the Z2 direction and the Z1 direction). The first circuit board component 61 and the second circuit board component 62 also overlap in the Z direction in a state in which a sheet-form insulating member 65 (see FIG. 3) has been sandwiched between the first board 61b and the second board 62b. The insulating member 65 is made of rubber or plastic. With the first circuit board component 61, the electronic parts 78 that are shorter in height are mounted on the surface on the opposite side from the first mounting surface 61a. Of course, alternatively or additionally, the electronic parts 78 can also be mounted on the first mounting surface 61a side of the first circuit board component 61. Similarly, with the second circuit board component 62, the electronic parts 79 that are shorter in height are mounted on the surface on the opposite side from the second mounting surface 62a. Of course, alternatively or additionally, the electronic parts 79 can also be mounted on the second mounting surface 62a side of the second circuit board component 62.

As shown in FIG. 1, in the first embodiment, the first board 61b and the second board 62b have an arc-shaped outer peripheral face 61c and an arc-shaped outer peripheral face 62c. The outer peripheral faces 61c and 62c are formed so as to conform to the inner face of the circular cylindrical wall part 41b of the socket 40. Therefore, when the circuit board component 60 is housed in the space 51 bounded by the concave component 41 inside the socket 40, the circuit board component 60 can be inserted into the space 51 while sliding in the Z direction (the Z2 direction) in which the socket 40 extends, without the outer peripheral face 61c of the first board 61b and the outer peripheral face 62c of the second board 62b snagging on the inner face of the wall part 41b.

As shown in FIG. 3, in the first embodiment, the circuit board component 60 is disposed on the non-emission side (the Z2 side) of the LED board 20 with the partition 12 of the housing 10 sandwiched in between. The circuit board component 60 is housed in the space 51 bounded by the concave component 41 inside the socket 40 such that the first mounting surface 61a (the first board 61b) and the second mounting surface 62a (the second board 62b) overlap with respect to the LED board 20.

As shown in FIG. 3, one end of each of a pair of covered wires 66a and 66b is connected to the first circuit board component 61 of the circuit board component 60. The other ends of the covered wires 66a and 66b are electrically connected by soldering or the like to terminal members 45a and 45b, respectively. The terminal members 45a and 45b are fixed to the bottom part 41a of the socket 40. Also, one end of each of a pair of covered wires 67a and 67b is connected to the second circuit board component 62 of the circuit board component 60. The covered wires 67a and 67b go through the hole 16 in the LED lighting device 100 and the hole 26 in the LED board 20, which are disposed concentrically. Then, the covered wires 67a and 67b go up to the emission-side surface (the mounting face 21a) of the LED board 20. As shown in FIG. 1, the other ends of the covered wires 67a and 67b (indicated by broken lines) are electrically connected by soldering to the lands 23a of the wiring pattern 23.

The first circuit board component 61 and the second circuit board component 62 are electrically connected by a pair of connector wires (jumper wires) 68a and 68b (positive electrode side and negative electrode side). The connector wires 68a and 68b are bendable metal wires. Therefore, the connector wires 68a and 68b can be bent back at about 180 degrees while maintaining a specific radius of curvature, without there being any acute angle parts. Thus, the first circuit board component 61 and the second circuit board component 62 can be disposed overlapping in the Z direction while electrically connected.

Consequently, with the LED lighting device 100 (see FIG. 2), the socket 40 from which the terminal members 45a and 45b protrude downward is plugged into a socket receptacle (power feed; not shown). AC power is supplied to the circuit board component 60, and DC power converted by the circuit board component 60 is supplied to the LED board 20. This is how the LED lighting device 100 is configured.

Next, the process for manufacturing the LED lighting device 100 (lighting device manufacturing method) in the first embodiment will be described through reference to FIGS. 1 to 5.

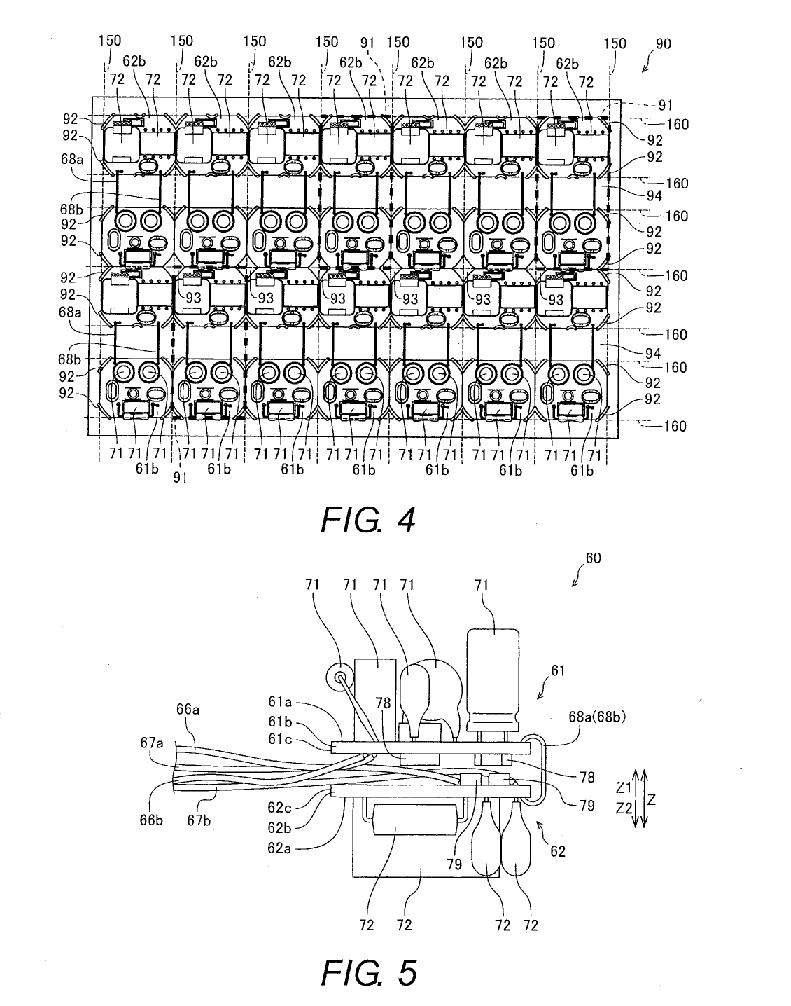

First, as shown in FIG. 4, a large circuit board 90 is readied that serves as the source of the circuit board component 60 (see FIG. 1). The large circuit board 90 here is an assembly member of a plurality of (fourteen in this embodiment) circuit boards 91 that is separably linked (in two rows and in seven columns, for example). Each of the circuit boards 91 includes the first circuit board component 61 having the first mounting surface 61a, and the second circuit board component 62 having the second mounting surface 62a. The electronic parts 71 are mounted on the first mounting surface 61a, while the electronic parts 72 are mounted on the second mounting surface 62a. In the large circuit board 90, the first circuit board component 61 and the second circuit board component 62 are linked in planar fashion via the pair of connector wires (jumper wires) 68a and 68b to form the single circuit board 91. In FIG. 4, a single region (indicated by the thick, rectangular box-like dashed lines) bounded by two adjacent dividing lines 150 (fine dashed lines) and two dividing lines 160 (fine dashed lines) that are perpendicular to the dividing lines 150 corresponds to the single circuit board 91. For the sake of convenience, the thick box-like dashed lines each indicating the circuit board 91 in the drawing are shown at only the main locations (three locations). Also, the electronic parts 78 (see FIG. 5) are pre-mounted on the rear faces of the first mounting surfaces 61a, while the electronic parts 79 (see FIG. 5) are pre-mounted on the rear faces of the second mounting surfaces 62a.

A plurality of slit-like dividing grooves 92 are formed between adjacent circuit boards 91 on the large circuit board 90. The dividing grooves 92 give shape to the first and second circuit board components 61 and 62 after separation. In addition to the dividing grooves 92, substantially diamond-shaped dividing grooves 93 are formed in the regions where the first circuit board components 61 and second circuit board components 62 of adjacent circuit boards 91 are demarcated. The first boards 61b of the first circuit board components 61 and the second boards 62b of the second circuit board components 62, whose square corners are bounded by the dividing grooves 92 and 93, have a surface area (planar shape) that is substantially the same as that of all the others.

In this state, a blade-like tool or the like (not shown) is used to divide the large circuit board 90 along the dividing lines 150 and 160. This divides the large circuit board 90 into the plurality of (fourteen) circuit boards 91. Simultaneously with this division, unnecessary board members 94 are removed from portions where the connector wires 68a and 68b cross. This results in a state of the circuit boards 91 in which the first circuit board components 61 (first boards 61b) and the second circuit board components 62 (second boards 62b) are linked in planar fashion via just the connector wires 68a and 68b. Also, in this state, the covered wires 66a and 66b (see FIG. 5) are soldered at one end to the first circuit board components 61. The covered wires 67a and 67b (see FIG. 5) are soldered at one end to the second circuit board components 62. The terminal members 45a and 45b (see FIG. 1) are soldered to the other ends of the covered wires 66a and 66b.

After this, a worker grasps the first circuit board component 61 (first board 61b) to hold the position steady, and then bends the second circuit board component 62 (second board 62b) back by approximately 180 degrees while maintaining a specific radius of curvature. Specifically, as shown in FIG. 5, the second circuit board component 62 overlaps the first circuit board component 61 as viewed in the Z direction so that the second mounting surface 62a of the second board 62b is facing in the opposite direction (the Z2 direction) with respect to the first mounting surface 61a of the first board 61b (the Z1 direction).

After this, the sheet-form insulating member 65 (see FIG. 3) is sandwiched between the mutually overlapping first circuit board component 61 and second circuit board component 62. As shown in FIG. 1, the circuit board component 60 is housed in the space 51 bounded by the concave component 41 inside the socket 40.

After this, the threaded members 81 are inserted into the holes 17 from the bottom face 11a side in a state in which the side (the Z2 side) of the housing 10 on which the concave component 13 (see FIG. 3) is formed is opposite the side of the socket 40 on which the concave component 41 opens, and in which the LED board 20 has not been attached. The threaded members 81 are inserted into the holes 14a in the bosses 14 underneath, and are fastened into the threaded holes 43 of the concave component 41 underneath. This links the housing 10 to the socket 40. Also, threaded members (not shown) are inserted and fastened from the side of the LED board 20 in a state in which the holes 28 of the LED board 20 and the threaded holes 18 of the housing 10 (concave component 11) overlap in the length direction (the Z direction). This fixes the LED board 20 to the housing 10 (concave component 11) in a state in which the non-mounting face 21e of the LED board 20 is pressed snugly against the bottom face 11a in the concave component 11. As shown in FIG. 1, the covered wires 67a and 67b are taken out through the hole 16 in the housing 10 and the hole 26 in the LED board 20, and then soldered to the lands 23a.

Finally, the outer peripheral face 30c of the lens member 30 is fitted into the concave component 11 while contacting with all the way around the inner face 11c formed near the opening (Z1 side) of the concave component 11 of the housing 10. This attaches the lens member 30 to the housing 10 with substantially no gaps. Also, the lens member 30 is fixed to the housing 10 by fitting the lens holder 31 into the lens member 30 from above. This is how the LED lighting device 100 (see FIG. 2) is manufactured.

In the first embodiment, as discussed above, the case component 50 houses the circuit board component 60 in its interior. The circuit board component 60 includes the first circuit board component 61 having the first mounting surface 61a, and the second circuit board component 62 having the second mounting surface 62a. The second mounting surface 62a of the second circuit component 62 is disposed so as to overlap the first mounting surface 61a of the first circuit board component 61. Thus, unlike when the circuit board component 60 is made up of a single circuit board component, it is divided into the first circuit board component 61 and the second circuit board component 62 that are made smaller than the single circuit board component. The first mounting surface 61a and the second mounting surface 62a are overlapped in planar fashion inside the case component 50. Thus, the first and second circuit board components 61 and 62, which are made compact, can be disposed three-dimensionally. Therefore, the circuit board component 60 can be housed more efficiently in the case component 50. Specifically, the circuit board component 60 can be housed more efficiently within the limited space inside the case component 50. Thus, there is less wasted space in the shape of the case component 50. This allows the case component 50 to be more compact. Also, this allows LED lighting device 100 to be obtained with less of an increase in the size of the device as a whole.

Also, in the first embodiment, the case component 50 includes the socket 40 having the bottom part 41a and the cylindrical wall part 41b connected to the bottom part 41a. The circuit board component 60 is housed with the first mounting surface 61a of the first circuit board component 61 and the second mounting surface 62a of the second circuit board component 62 overlapping. Consequently, the circuit board component 60 can be housed efficiently in the socket 40 of the LED lighting device 100 while the compact first and second circuit board components 61 and 62 are disposed three-dimensionally in the space 51 inside the socket 40. In this case, since the socket 40 can be made smaller, the LED lighting device 100 can be easily installed in cramped locations.

Also, in the first embodiment, the first mounting surface 61a of the first circuit board component 61 and the second mounting surface 62a of the second circuit board component 62 overlap inside the socket 40 in the direction (Z direction) in which the socket 40 extends. Consequently, the circuit board component 60 is stacked in the direction in which the socket 40 extends. Thus, the length of extension of the socket 40 (in the Z direction) can be shorter. Also, the circuit board component 60 is stacked in the direction in which the socket 40 extends. Thus, the size in the inside diameter direction of the socket 40 that is perpendicular to the direction in which the socket 40 extends (the Z direction) can also be easily reduced. Since the socket 40 can thus be easily made more compact, the LED lighting device 100 can also be easily made more compact.

Also, in the first embodiment, the socket 40 is circular cylindrical. The first circuit board component 61 has the first board 61b on which the electronic parts 71 and 78 are mounted. The second circuit board component 62 has the second board 62b on which the electronic parts 72 and 79 are mounted. The first board 61b and second board 62b respectively have the arc-shaped outer peripheral face 61c and the arc-shaped outer peripheral face 62c, respectively. The outer peripheral faces 61c and 62c are formed so as to conform to the inner face of the cylindrical wall part 41b of the socket 40. Consequently, when the circuit board component 60 is housed in the space 51 inside the socket 40, the circuit board component 60 can be inserted while sliding in the direction in which the socket 40 extends (the Z direction), without the outer peripheral face 61c of the first board 61b and the outer peripheral face 62c of the second board 62b snagging on the inner face of the wall part 41b of the socket 40.

Also, in the first embodiment, the circuit board component 60 is disposed on the non-emission side (the rear side) of the LED board 20. The circuit board component 60 is housed inside the case component 50 (the socket 40) such that the first mounting surface 61a and the second mounting surface 62a overlap with respect to the LED board 20. Consequently, the LED board 20 and the circuit board component 60 having the first and second circuit board components 61 and 62 can be disposed so that they are stacked in the Z direction in a state of being parallel to each other. Thus, even when a compact LED lighting device 100 is configured using a smaller (lower output) LED board 20, the size of the circuit board component 60 can easily be prevented from hindering the effort to achieve a more compact size.

Also, in the first embodiment, the first circuit board component 61 and the second circuit board component 62 are configured such that the first mounting surface 61a of the first board 61b and the second mounting surface 62a of the second board 62b overlap facing in mutually opposite directions (the Z2 direction and the Z1 direction). The main electronic parts 71 (out of the electronic parts 71 and 78) are mounted on the first mounting surface 61a, while the main electronic parts 72 (out of the electronic parts 72 and 79) are mounted on the second mounting surface 62a. Consequently, inside the case component 50, the first board 61b and the second board 62b can be overlapped appropriately close together while still spaced apart by a specific distance. Specifically, even though the first board 61b and the second board 62b are formed in substantially the same size (surface area), the circuit board component 60 can be configured in which the size of the case component 50 is not affected whatsoever. The benefits of mass producing the circuit board component 60 can be obtained proportionally to the fact that the first board 61b and the second board 62b can be formed in substantially the same size.

Also, in the first embodiment, the first circuit board component 61 and the second circuit board component 62 overlap with the insulating member 65 sandwiched between the first board 61b and the second board 62b. Consequently, even though the first board 61b and the second board 62b are disposed appropriately close together while still spaced apart by a specific distance, the first board 61b and the second board 62b can be prevented from coming into direct contact with each other by the insulating member 65. Thus, short-circuiting between the first circuit board component 61 and the second circuit board component 62 can be easily prevented.

Also, in the first embodiment, the first circuit board component 61 is a power supply circuit board component that converts AC power into DC power. The second circuit board component 62 is a control circuit board component that controls the voltage of the DC power converted by the power supply circuit board component and supplies this power to the LED board 20. Consequently, the circuit board component 60 can be divided into two functional parts according to the functions, namely, the power supply circuit board component (first circuit board component 61) and the control circuit board component (second circuit board component 62). Thus, during maintenance, such as when the LED lighting device 100 has malfunctioned, the malfunctioning site in the circuit board component 60 can be easily identified. This makes it easier to repair and replace the circuit board component 60.

Also, the manufacturing process in the first embodiment includes a step of forming the circuit board component 60 by dividing each of the circuit boards 91 in two (see FIG. 4) and bending the portion with the connector wires 68a and 68b by approximately 180 degrees, thereby overlapping the first mounting surface 61a of the first circuit board component 61 and the second mounting surface 62a of the second circuit board component 62 with each other. Consequently, unlike when the circuit board component 60 is formed by a single circuit board component, it can be divided into the first circuit board component 61 (first board 61b) and the second circuit board component 62 (second board 62b), each of which is smaller. Then, in the step of housing the circuit board component 60 in the case component 50 (socket 40), the smaller first circuit board component 61 and second circuit board component 62 can be disposed three-dimensionally inside the case component 50 (socket 40) by overlapping the first mounting surface 61a and the second mounting surface 62a in planar fashion. Thus, the circuit board component 60 can be housed more efficiently inside the case component 50 (socket 40). Specifically, the circuit board component 60 can be housed more efficiently inside the limited space of the case component 50 (socket 40). Thus, there is less wasted space in the shape of the case component 50. This allows the case component 50 (socket 40) that is more compact to be manufactured. This also allows the LED lighting device 100 to be obtained in which there is less of an increase in the overall size of the device.

The manufacturing process in the first embodiment also includes a step of preparing the large circuit board 90 having the plurality of (fourteen in this embodiment) separably linked circuit boards 91. In each of the circuit boards 91, the first circuit board component 61 and the second circuit board component 62 are linked in planar fashion via the connector wires 68a and 68b. The manufacturing process further includes a step of separating the large circuit board 90 into the individual circuit boards 91. Consequently, the plurality of the circuit boards 91 can be obtained by finely dividing the one large circuit board 90. Thus, the circuit boards 91 that are used to configure the circuit board components 60 can be mass produced from the large circuit board 90. Therefore, the benefits of mass producing the circuit board components 60 can be obtained.

### Second Embodiment

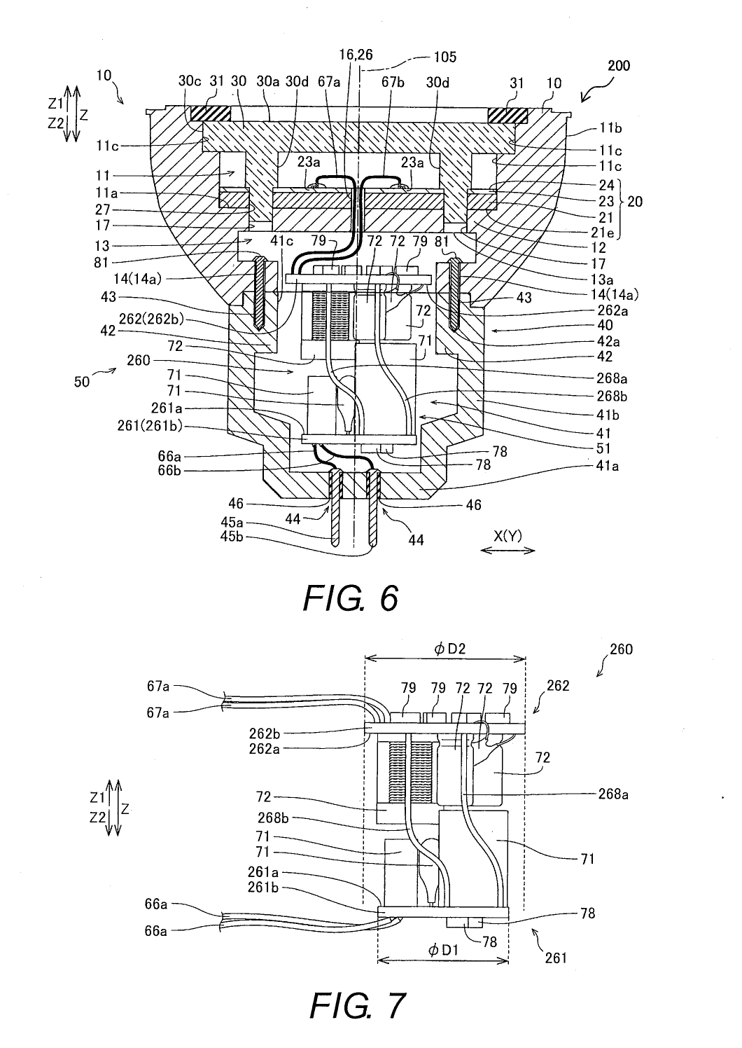

Referring now to FIGS. 6 and 7, an LED lighting device 200 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. In the illustrated embodiment, the LED lighting device 200 is spotlight type of LED (light-emitting diode) lighting device. The LED lighting device 200 basically includes a circuit board component 260 whose assembly structure differs from that of the circuit board component 60 given as an example in the first embodiment above. The LED lighting device 200 is an example of the “lighting device” of the present invention.

As shown in FIG. 6, the LED lighting device 200 is similar to the first embodiment in that it is configured such that the circuit board component 260 is housed inside the case component 50.

As shown in FIG. 6, the circuit board component 260 includes a first circuit board component 261 and a second circuit board component 262. The first circuit board component 261 has a first board 261b having a first mounting surface 261a on which the main electronic parts 71 are mounted. The second circuit board component 262 has a second board 262b having a second mounting surface 262a on which the main electronic parts 72 are mounted. In the second embodiment, the first circuit board component 261 and the second circuit board component 262 overlap in the Z direction so that the first mounting surface 261a of the first board 261b and the second mounting surface 262a of the second board 262b are opposite each other (face each other).

With the circuit board component 260, the first circuit board component 261 and the second circuit board component 262 are electrically connected by a pair of connector wires 268a and 268b (positive electrode side and negative electrode side).

As shown in FIG. 6, the portion of the wall part 41b corresponding to the bottom part 41a of the socket 40 is formed with an inside diameter that is smaller than that of the portion of the wall part 41b corresponding to the opening 41c of the socket 40 (this is the same as in the first embodiment). The first board 261b is formed in a substantially circular shape having a diameter D1 (see FIG. 7) when seen in plan view. The second board 262b is formed in a substantially circular shape having a diameter D2 (see FIG. 7) when seen in plan view. Here, D1<D2. Specifically, in the second embodiment, as shown in FIG. 7, the first board 261b of the first circuit board component 261 has a smaller surface area than the second board 262b of the second circuit board component 262. Therefore, as shown in FIG. 6, the circuit board component 260 is such that the first board 261b, which has a smaller surface area, and the second board 262b, which has a larger surface area, are housed overlapping in that order, from the bottom part 41a (Z2 side) of the socket 40 toward the opening 41c (Z1 side).

Also, as shown in FIG. 6, with the circuit board component 260, the electronic parts 71 which are relatively tall among the main electronic parts mounted on the first circuit board component 261, and the electronic parts 72 which are relatively short among the main electronic parts mounted on the second circuit board component 262 face each other in the Z direction. Furthermore, with the circuit board component 260, the electronic parts 71 which are relatively short among the main electronic parts mounted on the first circuit board component 261, and the electronic parts 72 which are relatively tall among the main electronic parts mounted on the second circuit board component 262 face each other in the Z direction. Consequently, even though the first circuit board component 261 and the second circuit board component 262 are disposed facing each other on the sides on which the main electronic parts 71 and 72 are mounted, the circuit board component 260 can be configured such that the taller convex region of one fits into the shorter concave region of the other. Thus, the distance between the first board 261b and the second board 262b in the Z direction can be suitably reduced. Specifically, the circuit board component 260 is housed in the space 51 in a state in which the height in the Z direction is reduced to the minimum in the adjustable range.

The rest of the configuration of the LED lighting device 200 in accordance with the second embodiment is substantially the same as the configuration of the LED lighting device 100 in accordance with the first embodiment above.

The process for manufacturing the LED lighting device 200 (lighting device manufacturing method) includes separately preparing the substantially circular first board 261b (diameter D1) and second board 262b (diameter D2) in advance. Then, the electronic parts 71 and 78, and the electronic parts 72 and 79 are mounted on these respectively. While the first circuit board component 261 (the first board 261b) is fixed, the second circuit board component 262 (the second board 262b) is overlapped such that the first mounting surface 261a of the first board 261b and the second mounting surface 262a of the second board 262b are opposite one another. The main electronic parts 71 and 72 are respectively mounted on the first and second mounting surfaces 261a and 262a. In this state, the first circuit board component 261 and the second circuit board component 262 are electrically connected by a pair of connector wires 268a and 268b (positive electrode side and negative electrode side). As shown in FIG. 7, the covered wires 66a, 66b, 67a, and 67b are connected to pre-assemble the circuit board component 260. Then, the circuit board component 260 is housed in the space 51 bounded by the concave component 41 inside the socket 40, as shown in FIG. 6.

The rest of the process for manufacturing the LED lighting device 200 is substantially the same as the process for manufacturing the LED lighting device 100 in accordance with the first embodiment above.

In the second embodiment, as discussed above, the first circuit board component 261 and the second circuit board component 262 overlap such that the first mounting surface 261a of the first board 261b and the second mounting surface 262a of the second board 262b are opposite each other. The main electronic parts 71 (out of the main electronic parts 71 and 78) are mounted on the first mounting surface 261a, while the main electronic parts 72 (out of the main electronic parts 72 and 79) are mounted on the second mounting surface 262a. Consequently, even when the main electronic parts face each other and the first circuit board component 261 and the second circuit board component 262 overlap each other, the circuit board component 260 can still be housed efficiently inside the case component 50. Since the electronic parts are interposed, the first board 261b and the second board 262b can be kept apart by a corresponding amount. Thus, the first circuit board component 261 (the first board 261b) and the second circuit board component 262 (the second board 262b) can be easily prevented from short-circuiting.

Also, in the second embodiment, the portion of the wall part 41b corresponding to the bottom part 41a of the socket 40 is formed with an inside diameter that is smaller than that of the portion of the wall part 41b corresponding to the opening 41c of the socket 40. The first board 261b of the first circuit board component 261 has a smaller surface area than the second board 262b of the second circuit board component 262. The circuit board component 260 is housed such that the first board 261b and the second board 262b overlap in that order, from the bottom part 41a of the socket 40 toward the opening 41c. Consequently, even with the circuit board component 260 in which the first board 261b and the second board 262b are separated by a certain amount (corresponding to the amount by which the electronic parts are interposed between the first board 261b and the second board 262b), the circuit board component 260 (the first circuit board component 261 and the second circuit board component 262) can be easily housed inside the socket 40 so as to correspond to the shape inside the socket 40. The other effects of the second embodiment are the same as those of the first embodiment above.

The embodiments disclosed herein are just examples in every respect, and should not be interpreted as being limiting in nature. The scope of the invention being indicated by the appended claims rather than by the above description of the embodiments, all modifications within the meaning and range of equivalency of the claims are included.

For example, in the first and second embodiments above, the spotlight-type LED lighting devices 100 and 200 are applied as the “lighting device” of the present invention. However, the present invention is not limited to this. For example, the present invention can be applied to a light bulb type of LED lighting device having a cover member (lens member) with a spherical (hemispherical) shape.

Also, in the first and second embodiments above, the LED board 20 including the LED element components 22 is used as the “light source component” of the present invention. However, the present invention is not limited to this. The “light source component” of the present invention can instead be a light source other than LED elements, such as a filament type. The present invention may be applied to a lighting device in which commercial AC power is sent directly to a filament. However, more preferably, the present invention can be applied to a lighting device having a circuit board component that first receives commercial AC power within the main body of the device, and adjusts it to a specific voltage and frequency.

Also, in the first and second embodiments above, the electronic parts are mounted on both sides of the first circuit board component (the first board) and the second circuit board component (the second board). However, the present invention is not limited to this. The circuit board component 60 can be such that electronic parts are mounted only on the first and second mounting surfaces 61a and 62a that are facing away in opposite directions. Also, the circuit board component 260 can be such that electronic parts are mounted only on the first and second mounting surfaces 261a and 262a that are facing towards each other.

Also, in the first and second embodiments above, the case component 50 made by the housing 10 and the socket 40 is formed in a substantially round cylindrical shape. However, the present invention is not limited to this. The case component 50 can have a square cylindrical shape, or a polyhedral cylindrical shape. In this case, the “first board” and “second board” of the present invention are preferably configured so that they have a planar shape corresponding to the interior shape (the lateral cross sectional shape) of the case component (socket).

Also, in the first and second embodiments above, the circuit board components 60 and 260 have a two-level structure with the first circuit board components 61 and 261, and the second circuit board components 62 and 262, respectively. However, the present invention is not limited to this. Depending on the circuit configuration, the circuit board component can be such that a third circuit board component, a fourth circuit board component, etc., are further provided to each a three- or four-level structure. However, if the circuit board component has a multilayer structure, the case component (socket) size increases in the stacking direction. Thus, the “circuit board component” of the present invention is preferably configured such that its external shape is kept within a cubic shape.

Also, in the first and second embodiments above, the LED board 20 is configured using the aluminum base component 21. However, the present invention is not limited to this. For example, the LED board 20 (base component 21) can be configured using a metal material with good thermal conductivity other than aluminum.

Also, in the first and second embodiments above, the housing 10 is configured using an aluminum metal material. However, the present invention is not limited to this. For example, the housing 10 can be configured using a metal material other than aluminum, or a ceramic material, with good thermal conductivity.

Also, in the first and second embodiments above, the socket 40 is configured using an aluminum metal material. However, the present invention is not limited to this. For example, the socket 40 can be configured using a metal material other than aluminum, or a ceramic material, with good thermal conductivity.

The lighting device pertaining to one aspect includes a light source component, a circuit board component, and a case component. The circuit board component is configured to supply power to the light source component. The case component houses the circuit board component in an interior of the case component. The circuit board component includes first and second circuit board components. The first circuit board component has a first mounting surface on which a first electronic part is mounted. The second circuit board component has a second mounting surface on which a second electronic part is mounted. The second mounting surface of the second circuit board component overlaps with the first mounting surface of the first circuit board component.

As discussed above, the lighting device includes the case component designed to be capable of housing the circuit board component in its interior. The circuit board component includes the first circuit board component having the first mounting surface, and the second circuit board component that is disposed so as to overlap with the first mounting surface of the first circuit board component. The term “overlapping” means the first and second mounting surfaces are aligned with respect to each other as viewed in a direction, such as an axial direction of the lighting device (e.g., the Z direction). Thus, the term “overlapping” does not require a direct contact between the first and second mounting surfaces. Rather, the first and second mounting surfaces spaced apart from each other in the direction, such as the axial direction of the lighting device. The circuit board component can be divided into two smaller parts, namely, the first circuit board component and the second circuit board component, as opposed to when it is made up of a single circuit board component. The first and second circuit board components are made smaller, and have the first and second mounting surfaces, respectively, that overlap with respect to each other in planar fashion. Thus, the first and second circuit board components can be disposed three-dimensionally inside the case component. As a result, the circuit board component can be housed more efficiently in the case component. Specifically, the circuit board component can be housed more efficiently within the limited space inside the case component. Thus, there is less wasted space in the shape of the case component. This allows the case component to be more compact. This also avoids an increase in the size of the lighting device as a whole.

With the lighting device, the case component includes a socket. The socket has a bottom part and a cylindrical wall part that extends from the bottom part. The circuit board component is at least partially disposed within a space inside the socket such that the first mounting surface of the first circuit board component and the second mounting surface of the second circuit board component overlap with each other. With this configuration, the circuit board component has two smaller components, namely, the first circuit board component and the second circuit board component. The first and second circuit components are disposed three-dimensionally in this internal space of the socket. Thus, the circuit board component can be efficiently housed in the socket of the lighting device. In this case, since the socket can be made more compact, it is easier to install the lighting device in cramped spaces.

With the above-mentioned configuration in which the case component includes the socket, the first mounting surface of the first circuit board component and the second mounting surface of the second circuit board component overlap with each other inside the socket in a direction along which the socket extends. With this configuration, the circuit board component can be stacked in the direction along which the socket extends. Thus, the socket will extend in a shorter length. Also, since the circuit board component is stacked in the direction along which the socket extends, the size of the socket in its inside diameter direction, which is perpendicular to the direction in which the socket extends, can also be easily reduced. Since this affords a more compact socket, the size of the lighting device can also be correspondingly reduced with ease.

In this case, the socket has a round or circular cylindrical shape. The first and second circuit board components have first and second boards, respectively. The first and second electronic parts are mounted on the first and second boards, respectively. The first board and the second board each have an arc-shaped outer peripheral face that conforms to an inner face of the cylindrical wall part of the socket. With this configuration, upon housing the circuit board component in the space inside the socket, the circuit board component can be inserted by being slid in the direction in which the socket extends, without the outer peripheral faces of the first board and second board snagging unnecessarily on the inner face of the wall part of the socket.

With the lighting device, the circuit board component is disposed on a non-emission side of the light source component with respect to the light source component. The circuit board component is disposed inside the case component such that the first and second mounting surfaces overlap with respect to the light source component. With this configuration, the light source component and the circuit board component having the first and second circuit board components are disposed so as to be stacked in a state of being parallel to each other. Thus, even if a compact lighting device is configured using a light source component that is smaller in size (smaller output power), the size of the circuit board component can be easily prevented from hindering a reduction in size.

With the lighting device, the first and second circuit board components have first and second boards, respectively. The first and second electronic parts are mounted on the first and second boards, respectively. The first and second circuit board components overlap with each other such that the first mounting surface of the first board and the second mounting surface of the second board on which the main electronic parts are mounted, respectively, face away from each other in opposite directions. With this configuration, the first board and the second board can be superposed suitably close together, while being spaced apart by a specific distance. Specifically, even though the first and second boards are formed in substantially the same size (the same surface area), the circuit board component does not affect the size of the case component whatsoever. The benefits of mass producing the circuit board component can be obtained as a result of forming the first and second boards in substantially the same size.

In this case, the first and second circuit board components overlap with each other such that an insulating member is sandwiched between the first board and the second board. With this configuration, even when the first board and the second board are disposed suitably close together, while being spaced apart by a specific distance, the first board and second board can be prevented by the insulating member from coming into direct contact with each other. Thus, short-circuiting between the first circuit board component and the second circuit board component can be easily prevented.

With the lighting device, the first and second circuit board components have first and second boards, respectively. The first and second electronic parts are mounted on the first and second boards, respectively. The first and second circuit board components overlap with each other such that the first mounting surface of the first board and the second mounting surface of the second board, on which the main electronic parts are mounted, respectively, face towards each other. With this configuration, even when the first circuit board component and the second circuit board component are superposed while the main electronic parts facing each other, the circuit board component can still be efficiently housed in the case component. Also, the first and second boards can be separated by the first and second electronic parts between them. Thus, short-circuiting between the first circuit board component (first board) and the second circuit board component (second board) can be easily prevented.

In this case, the case component includes a socket. The socket has a bottom part and a cylindrical wall part that extends from the bottom part. The wall part has an inside diameter at a portion corresponding to the bottom part of the socket that is smaller than an inside diameter of the wall part at a portion of the wall part corresponding to the opening of the socket. The first board of the first circuit board component has a surface area that is smaller than that of the second board of the second circuit board component. The circuit board component is at least partially disposed within the socket such that the first board and the second board overlap with each other in an order of the first board and the second board from the bottom part of the socket toward the opening of the socket. With this configuration, even with the circuit board component in which the first board and second board are separated somewhat by having the first and second electronic parts in between the first board and second board, the circuit board component (the first circuit board component and the second circuit board component) can be easily housed inside the socket according to the shape of the socket interior.

With the lighting device, the first circuit board component includes a power supply circuit board component that is configured to convert AC power into DC power. The second circuit board component includes a control circuit board component that is configured to control a voltage of the DC power converted by the power supply circuit board component and configured to supply the DC power to the light source component. With this configuration, the circuit board component can be divided into two functional parts, namely, the power supply circuit board component (first circuit board component) and the control circuit board component (second circuit board component). Thus, during maintenance, such as when the lighting device has malfunctioned, the malfunctioning site in the circuit board component can be easily identified. This makes it easier to repair and replace the circuit board component.

The lighting device manufacturing method pertaining to one aspect includes preparing a large circuit board with a plurality of separably linked circuit boards. Each of the circuit boards includes first and second circuit board components that are linked in a planar fashion via a connecting wiring. The first circuit board component has a first mounting surface on which a first electronic part is mounted. The second circuit board component has a second mounting surface on which a second electronic part is mounted. The method also includes separating the large circuit board into individual circuit boards. The method also includes forming a circuit board component by dividing each of the circuit boards into the first and second circuit board components and by bending the first and second circuit board components at the connecting wiring such that the first mounting surface of the first circuit board component and the second mounting surface of the second circuit board component overlap with each other. The method also includes housing the circuit board component in a case component, and electrically connecting the circuit board component housed in the case component to a light source component.

The lighting device manufacturing method, as discussed above, includes forming the circuit board component by dividing each of the circuit boards in two and by bending them at the connecting wiring such that the first mounting surface of the first circuit board component and the second mounting surface of the second circuit board component overlap with each other. Thus, unlike when the circuit board component is made up of a single circuit board component, it is divided into the first circuit board component and the second circuit board component that are each smaller. Specifically, the first circuit board component and the second circuit board component are made smaller because the first mounting surface and the second mounting surface overlap in planar fashion. Then, during housing the circuit board component in the case component, the first circuit board component and the second circuit board component can be disposed three-dimensionally inside the case component. Thus, the circuit board component can be housed more efficiently in the case component. Specifically, the circuit board component can be housed more efficiently within the limited space inside the case component. Thus, there is less wasted space in the shape of the case component. This allows the case component that is more compact to be manufactured. This also allows the lighting device to be obtained in which an increase in the size of the device as a whole is avoided. Also, the method includes preparing the large circuit board with the plurality of separably linked circuit boards. Each of the circuit boards has the first circuit board component and the second circuit board component that are linked in planar fashion via the connecting wiring. Furthermore, the method includes separating the large circuit board into individual circuit boards. Thus, the plurality of circuit boards can be obtained by finely separating the single large circuit board. Therefore, the circuit boards that each form the circuit board component can be mass produced from the large circuit board. Therefore, the benefits of mass production of the circuit board component can be obtained.

With the present invention, as discussed above, an increase in the size of the device as a whole can be reduced.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A lighting device comprising:
a light source component;
a circuit board component configured to supply power to the light source component; and
a case component housing the circuit board component in an interior of the case component,
the circuit board component including first and second circuit board components, the first circuit board component having a first mounting surface on which a first electronic part is mounted, the second circuit board component having a second mounting surface on which a second electronic part is mounted, the second mounting surface of the second circuit board component overlapping with the first mounting surface of the first circuit board component.

2. The lighting device according to claim 1, wherein
the case component includes a socket, the socket having a bottom part and a cylindrical wall part that extends from the bottom part, and
the circuit board component is at least partially disposed within in a space inside the socket such that the first mounting surface of the first circuit board component and the second mounting surface of the second circuit board component overlap with each other.

3. The lighting device according to claim 2, wherein
the first mounting surface of the first circuit board component and the second mounting surface of the second circuit board component overlap with each other inside the socket in a direction along which the socket extends.

4. The lighting device according to claim 3, wherein
the socket has a round cylindrical shape,
the first and second circuit board components have first and second boards, respectively, the first and second electronic parts being mounted on the first and second boards, respectively, and
the first board and the second board each have an arc-shaped outer peripheral face that conforms to an inner face of the cylindrical wall part of the socket.

5. The lighting device according to claim 1, wherein
the circuit board component is disposed on a non-emission side of the light source component with respect to the light source component, the circuit board component being disposed inside the case component such that the first and second mounting surfaces overlap with respect to the light source component.

6. The lighting device according to claim 1, wherein
the first and second circuit board components have first and second boards, respectively, the first and second electronic parts being mounted on the first and second boards, respectively, and
the first and second circuit board components overlap with each other such that the first mounting surface of the first board and the second mounting surface of the second board face away from each other in opposite directions.

7. The lighting device according to claim 6, wherein
the first and second circuit board components overlap with each other such that an insulating member is sandwiched between the first board and the second board.

8. The lighting device according to claim 1, wherein
the first and second circuit board components have first and second boards, respectively, the first and second electronic parts being mounted on the first and second boards, respectively, and
the first and second circuit board components overlap with each other such that the first mounting surface of the first board and the second mounting surface of the second board face towards each other.

9. The lighting device according to claim 8, wherein
the case component includes a socket, the socket having a bottom part and a cylindrical wall part that extends from the bottom part,
the wall part has an inside diameter at a portion corresponding to the bottom part of the socket that is smaller than an inside diameter at a portion corresponding to an opening of the socket,
the first board of the first circuit board component has a surface area that is smaller than that of the second board of the second circuit board component, and
the circuit board component is at least partially disposed within the socket such that the first board and the second board overlap with each other in an order of the first board and the second board from the bottom part of the socket toward the opening of the socket.

10. The lighting device according to claim 1, wherein
the first circuit board component includes a power supply circuit board component that is configured to convert AC power into DC power, and
the second circuit board component includes a control circuit board component that is configured to control a voltage of the DC power converted by the power supply circuit board component and configured to supply the DC power to the light source component.

11. A lighting device manufacturing method comprising:
preparing a large circuit board with a plurality of separably linked circuit boards, each of the circuit boards including first and second circuit board components that are linked in a planar fashion via a connecting wiring, the first circuit board component having a first mounting surface on which a first electronic part is mounted, the second circuit board component having a second mounting surface on which a second electronic part is mounted;
separating the large circuit board into individual circuit boards;
forming a circuit board component by dividing each of the circuit boards into the first and second circuit board components and by bending the first and second circuit board components at the connecting wiring such that the first mounting surface of the first circuit board component and the second mounting surface of the second circuit board component overlap with each other;
housing the circuit board component in a case component; and
electrically connecting the circuit board component housed in the case component to a light source component.
